(19) United States
(12) Patent Application Publication
(10) Pub. No.: US 2022/0380045 A1
(43) Pub. Date: Dec. 1, 2022

(54) Combination UAV

(71) Applicant: Shanghai Autoflight Co., Ltd., Kunshan City (CN)

(72) Inventor: Yu Tian, Hong Kong SAR (CN)

(21) Appl. No.: 17/827,203

(22) Filed: May 27, 2022

(30) Foreign Application Priority Data
May 27, 2021 (CN) 202121160014.1

(51) Int. Cl. B64C 39/02; B64C 37/02; B64C 11/46

(52) U.S. Cl. CPC B64C 39/024; B64C 37/02; B64C 11/46; B64C 2201/122

(57) ABSTRACT

A combination unmanned aerial vehicle (UAV) having a fixed wing UAV, a plurality of rotor UAVs, a first communication component and a plurality of second communication components. The first communication component is arranged on the fixed wing UAV, and the plurality of second communication components are correspondingly arranged on the plurality of rotor UAVs. The first communication component can communicate with the plurality of second communication components. When operating in long-distance and complex surrounding areas, it can fly to a designated position through the fixed wing UAV, and then release the plurality of rotor UAVs, which may carry out reconnaissance operations on one or more targets in one area at the same time, or operate on multiple targets in multiple areas, and transmit signal commands in real time through the first communication component and the second communication component.

### TECHNICAL FIELD

The application relates to the technical field of aircraft, in particular to a combination UAV.

### BACKGROUND ART

The existing fixed wing UAV is not convenient for low-altitude flight reconnaissance in cities or mountainous areas with complex environment. The rotor UAV is simple to operate and flexible in flight route for flight reconnaissance in complex terrains. However, due to space constraints, the flight time of the multi-rotor UAV is less than that of the fixed wing UAV, which requires pilots to take off nearby and cannot operate from a long distance.

### SUMMARY OF THE APPLICATION

The application aims to provide a combination UAV to solve the problems that the fixed wing UAV in the prior art is not convenient for low-altitude flight reconnaissance in cities or mountainous areas with complex environment, and the rotor UAV needs to take off nearby.

In order to achieve this purpose, the application adopts the following technical solution:

A combination UAV, comprising:
a fixed wing UAV, which is arranged on a carrying part;
a plurality of rotor UAVs, which are arranged on the carrying part;
a first communication component and a plurality of second communication components, the first communication component is arranged on the fixed wing UAV, the plurality of the second communication components are arranged on the plurality of rotor UAVs one by one, and the first communication component is able to communicate and transmit with the plurality of second communication components. The carrying part is protrudingly provided with a plurality of snap-on protrusions, and the plurality of rotor UAVs are correspondingly connected to the plurality of snap-on protrusions one by one.

The carrying part is provided with a holding tank, and the plurality of the rotor UAVs are arranged in the holding tank.

The plurality of limiting elements are arranged in the holding tank, and the plurality of limiting elements are used to limit the positions of the plurality of rotor UAVs one by one.

The tail of the fixed wing UAV is provided with an air flow guide.

A speed sensor is arranged on one side of the wing of the fixed wing UAV close to the nose.

A power supply is arranged on the fixed wing UAV, and the plurality of the rotor UAVs are electrically connected with the power supply.

The fixed wing UAV is provided with a leg.

A roller is arranged on the leg.

Both the first communication component and the second communication component are relay modules.

The beneficial effects of the application: a carrying part is arranged on the fixed wing UAV, and a plurality of rotor UAVs are arranged on the carrying part. In this way, a first communication component can communicate with the plurality of second communication components. When working in long-distance regions with complex surroundings, it can fly to a designated position through the fixed wing UAV, and then release the plurality of rotor UAVs, which may conduct reconnaissance operations on one or more targets in one area at the same time, and can also operate on multiple targets in multiple areas, and transmit signal commands in real time through the first communication component and the second communication component, thereby solving the problems that a single fixed wing UAV in the prior art is not convenient for low altitude reconnaissance in cities or mountainous areas with complex environment, and it needs to limit the take-off location.

### DESCRIPTION OF THE FIGURES

FIG. 1 is the overall axonometric structure diagram of a combination UAV of the application;

FIG. 2 is an axonometric structural diagram of a fixed wing UAV in a combination UAV of the application;

FIG. 3 is an axonometric structural diagram of a rotor UAV in a combination UAV of the application;

FIG. 4 is a schematic diagram of the operation process of a combination UAV of the application.

Wherein,

1. Fixed wing UAV; 11. Air flow guide; 12. Speed sensor; 13. Leg; 131. Roller 2. Rotor UAV

### DETAILED DESCRIPTION

The technical solution of the application is further described below in combination with the drawings and the embodiments. It can be understood that the embodiments described here are only used to explain the application, rather than to limit the application. In addition, it should be noted that for the convenience of description, only some parts related to the application are shown in the drawings, not all.

In the description of the application, it should be noted that unless otherwise specified and limited, the terms “installation”, “connect” and “connection” should be understood in a broad sense. For example, it can be fixed connection or detachable connection. It can be mechanical connection or electrical connection. It can be connected directly or indirectly through an intermediate medium, and it can be the connection between the two components. For those skilled in the art, the specific meaning of the above terms in the application can be understood in specific circumstances.

In the application, unless otherwise clearly specified and limited, the first feature “on” or “under” the second feature may include the direct contact between the first and second features, or the contact between the first and second features that is not direct contact, but through another feature between them. Moreover, the first feature “on”, “over”, and “above” the second feature may include the first feature directly above and obliquely above the second feature, or only indicates that the horizontal height of the first feature is higher than the second feature. The first feature “under”, “below” and “beneath” the second feature, may include the first feature directly below and obliquely below the second feature, or only indicate that the horizontal height of the first feature is smaller than that of the second feature.

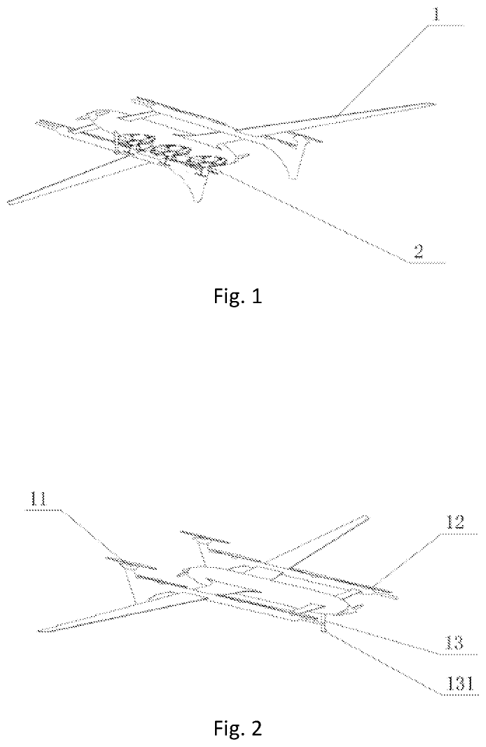

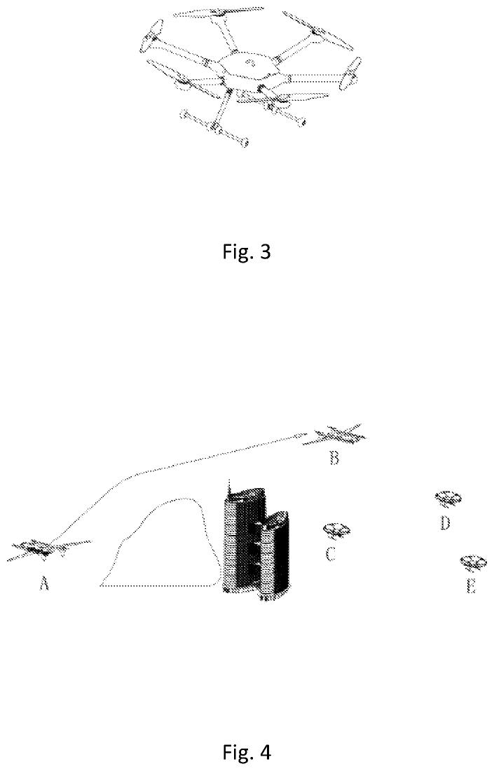

As shown in FIGS. 1-4, this embodiment provides a combination UAV, including: a fixed wing UAV 1, a plurality of rotor UAVs 2, a first communication component and a plurality of second communication components. The fixed wing UAV 1 is provided with a carrying part; the plurality of rotor UAVs 2 are arranged on the carrying part. The first communication component is arranged on the fixed wing UAV 1, and the plurality of second communication components are arranged on the plurality of rotor UAVs 2 one by one. The first communication component is able to communicate and transmit with the plurality of second communication components. The combination UAV provided in this embodiment operates in long-distance regions with complex surroundings by fixing the plurality of rotor UAVs 2 under the large fixed wing UAV 1, and it may fly to the designated position through the fixed wing UAV 1, and then release the plurality of rotor UAVs 2. The plurality of rotor UAVs 2 may conduct reconnaissance operations on one or more targets in one area at the same time, or operate on multiple targets in multiple areas, and transmit signal instructions in real time through the first communication component and the second communication component, thereby solving the problems that the single fixed wing UAV in the prior art is not convenient for low-altitude flight reconnaissance in cities or mountainous areas with complex environment, and that the take-off location of the single rotor UAV is limited.

Specifically, the carrying part is protrudingly provided with a plurality of snap-on protrusions, the upper part of the plurality of rotor UAVs 2 is provided with a buckle, the plurality of rotor UAVs 2 are connected to the plurality of snap-on protrusions one by one through the buckle, and the plurality of rotor UAVs 2 can be released by control during operation.

A holding tank can also be provided in the carrying part of the fixed wing UAV 1, and the plurality of rotor UAVs 2 are arranged in the holding tank. Further, the plurality of limiting elements are arranged in the holding tank, and the plurality of limit elements are used to limit the position of the plurality of rotor UAVs 2 one by one. The plurality of rotor UAVs 2 do not interfere with each other. During operation, the plurality of rotor UAVs 2 are controlled to fly out of the holding tank.

The tail of the fixed wing UAV 1 is rotatably provided with an air flow guide 11, and the flight direction of the fixed wing UAV 1 can be controlled by controlling the rotation angle of the air flow guide 11.

A speed sensor 12 is arranged on the side of the wing of the fixed wing UAV 1 close to the nose, which can detect the flight speed of the fixed wing UAV 1 in real time and feed it back to the control system.

The fixed wing UAV 1 is provided with a power supply, and the plurality of rotor UAVs 2 can be electrically connected with the power supply. The power supply can provide power for the fixed wing UAV 1. At the same time, when the plurality of rotor UAVs 2 are mounted on the fixed wing UAV 1, they can also be charged through the power supply.

The fixed wing UAV 1 is provided with a leg 13 to prevent fuselage wear during take-off and landing. Further, the leg 13 are provided with roller 131 to buffer the fixed wing UAV 1 during take-off and landing. Further, the plurality of rotor UAVs 2 are rotationally provided with supports, which can be retracted during mounting and expanded when releasing for work by controlling.

In this embodiment, the first communication component and the second communication component are relay modules. In other embodiments, the first communication component and the second communication component can also adopt data transmission, and there is no excessive restriction here.

The specific usage of the combination UAV of this embodiment is shown in FIG. 4:

S1. The fixed wing UAV 1 carries a plurality of rotor UAVs 2 for taking off from position A;

S2. After the fixed wing UAV 1 flies around the mountains or buildings to the designated point position B (high altitude), it releases one or more rotor UAVs 2 below through the control system to make the rotor UAVs 2 reach position C, position D, position E, etc. to carry out reconnaissance operations on different targets;

S3. The fixed wing UAV 1 hovers at high altitude and transmits signal commands in real time through the first communication component and the second communication component to communicate with the plurality of rotor UAVs 2 and play a relay role. Obviously, the above embodiments of the application are only given to clearly illustrate the examples given by the application, rather than to limit the embodiment of the application. For those skilled in the art, other changes or alterations in different forms may be made on the basis of the above description. It is unnecessary and impossible to enumerate all the embodiments here. Any modification, equivalent replacement and improvement made based on the spirit and principles of the application shall fall within the breadth and scope of the claims of the application.

1. A combination UAV (unmanned aerial vehicle), characterized in that it is comprising:
a fixed wing UAV (1), which is provided with a carrying part;
a plurality of rotor UAVs (2), which are arranged on the carrying part;
a first communication component and a plurality of second communication components, the first communication component is arranged on the fixed wing UAV (1), the plurality of second communication components are arranged on the plurality of rotor UAVs (2) one by one, and the first communication component is able to communicate and transmit with the plurality of second communication components.

2. The combination UAV according to claim 1, which is characterized in that the carrying part is protrudingly provided with a plurality of snap-on protrusions, and the plurality of rotor UAVs (2) are correspondingly connected to the plurality of snap-on protrusions one by one.

3. The combination UAV according to claim 1, which is characterized in that the carrying part is provided with a holding tank, and the plurality of rotor UAVs (2) are arranged in the holding tank.

4. The combination UAV according to claim 3, which is characterized in that a plurality of limiting elements are arranged in the holding tank, and the plurality of limiting elements are used to limit the positions of the plurality of rotor UAVs (2) one by one.

5. The combination UAV according to claim 1, which is characterized in that the tail of the fixed wing UAV (1) is rotatably provided with an air flow guide (11).

6. The combination UAV according to claim 1, which is characterized in that a speed sensor (12) is arranged on one side of the wing of the fixed wing UAV (1) close to the nose.

7. The combination UAV according to claim 1, which is characterized in that a power supply is arranged on the fixed wing UAV (1), and the plurality of rotor UAVs (2) are electrically connected with the power supply.

8. The combination UAV according to claim 1, which is characterized in that the fixed wing UAV (1) is provided with a leg (13).

9. The combination UAV according to claim 8, which is characterized in that a roller (131) is arranged on the leg (13).

10. The combination UAV according to claim 1, which is characterized in that the first communication component and the second communication component are relay modules.
